(19) United States
(12) Patent Application Publication
(10) Pub. No.: US 2025/0240827 A1
(43) Pub. Date: Jul. 24, 2025

(54) CROSS-LINK INTERFERENCE (CLI) AWARE PHYSICAL RANDOM ACCESS (PRACH)TRANSMISSION WITH SUB-BAND FULL-DUPLEX (SBFD)

(71) Applicant: Lenovo (Singapore) Pte. Ltd., Singapore (SG)

(72) Inventor: Khaled Nafez Rauf ARDAH, Ilmenau (DE)

(21) Appl. No.: 19/082,975

(22) Filed: Mar. 18, 2025

Related U.S. Application Data
(60) Provisional application No. 63/575,076, filed on Apr. 5, 2024.

(51) Int. Cl. H04W 74/0833; H04L 5/00; H04W 52/38

(52) U.S. Cl. CPC H04W 74/0833; H04L 5/0053; H04W 52/38

(57) ABSTRACT

Various aspects of the present disclosure relate to the implementation of certain conditions when allowing or facilitating physical random access (PRACH) preamble transmissions during sub-band full-duplex (SBFD) symbols. For example, a wireless communication system may implement limitations on which SBFD symbols and/or when certain SBFD slots/symbols may be associated with PRACH preamble transmissions (e.g., which RACH occasion (RO) of an SBFD slot/symbol).

This application claims priority to U.S. Provisional Patent Application No. 63/575,076, filed on Apr. 5, 2024, entitled CROSS-LINK INTERFERENCE (CLI) AWARE PHYSICAL RANDOM ACCESS (PRACH) TRANSMISSION WITH SUB-BAND FULL-DUPLEX (SBFD), which is hereby incorporated by reference in its entirety.

### TECHNICAL FIELD

The present disclosure relates to wireless communications, and more specifically to performing cross-link interference (CLI) aware physical random access channel (PRACH) transmissions with sub-band full-duplex (SBFD).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support time division duplexing (TDD), which involves splitting resources between uplink (UL) and downlink (DL) in a time domain. In some cases, one or more network communication devices or user communication devices may experience CLI. To mitigate or decrease CLI, the wireless communications system, including the one or more network communication devices or user communication devices, may support use of synchronized (e.g., phase and frequency synchronized) and/or identical patterns of TDD (also referred to herein as TDD patterns). In some other cases, the wireless communications system may support sub-band full-duplex (SBFD), where user communication devices can be configured to transmit UL signals in a sub-band on DL symbols, or transmit DL signals in a sub-band on UL symbols. Although the user communication devices may not have FD capabilities, network communication devices may be configured to include the FD capabilities and perform transmissions within the sub-bands.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that utilize various techniques when enabling the use of SBFD resources (e.g., slots or symbols) for random access channel (RACH) procedures.

Some implementations of the method and apparatuses described herein may further include a UE for wireless communication, comprising at least one memory, and at least one processor coupled with the at least one memory and configured to cause the UE to receive a RACH configuration message for SBFD operations, and transmit a PRACH preamble on a selected RACH occasion (RO), wherein the selected RO falls within an SBFD uplink (UL) sub-band.

In some implementations of the method and apparatuses described herein, the at least one processor is further configured to cause the UE to receive a resource configuration message that indicates time symbols and frequency symbols used for the SBFD operations.

In some implementations of the method and apparatuses described herein, the RACH configuration message indicates at least one of a reference signal received power (RSRP) threshold associated with a reference signal (RS) index set, a CLI threshold, a signal-to-leakage ratio (SLR) threshold associated with a RS index set, a maximum PRACH uplink transmit power threshold associated with an RS index set, a random access (RA) contention class, an RA trigger event index, a deactivated ROs index, two preambleReceivedTargetPower values, and two uplink power ramping values.

In some implementations of the method and apparatuses described herein, a first preambleReceivedTargetPower value of the two preambleReceivedTargetPower values is used to determine a PRACH transmit power during SBFD slots and a second preambleReceivedTargetPower value of the two preambleReceivedTargetPower values is used to determine the PRACH transmit power during UL-only slots.

In some implementations of the method and apparatuses described herein, the determined PRACH transmit power does not exceed the maximum PRACH uplink transmit power threshold associated with the RS index set.

In some implementations of the method and apparatuses described herein, the preambleReceivedTargetPower value of SBFD slots is explicitly indicated to the UE.

In some implementations of the method and apparatuses described herein, the preambleReceivedTargetPower value of SBFD slots is indicated relative to the preambleReceivedTargetPower value of the UL-only slots.

In some implementations of the method and apparatuses described herein, a first uplink power ramping value of the two uplink power ramping values is used to increase a PRACH transmit power during the SBFD slots, and a second uplink power ramping value of the two uplink power ramping values is used to increase the PRACH transmit power during UL-only slots.

In some implementations of the method and apparatuses described herein, the uplink power ramping value of SBFD slots is explicitly indicated to the UE.

In some implementations of the method and apparatuses described herein, the uplink power ramping value of SBFD slots is indicated relative to the uplink power ramping value of the UL-only slots.

In some implementations of the method and apparatuses described herein, the at least one processor is further configured to cause the UE to receive a cross-link interference reference signal received power (CLI-RSRP) or a CLI-reference signal strength indicator (RSSI) measurement resource for measuring the CLI-RSRP or CLI-RSSI of a second UE.

In some implementations of the method and apparatuses described herein, the at least one processor is configured to transmit the PRACH preamble on the selected RO when an RSRP value of a measured RS is greater than or equal to an indicated RSRP threshold associated with the RS.

In some implementations of the method and apparatuses described herein, the at one processor is configured to transmit the PRACH preamble on the selected RO when an SLR value determined using an RSRP of a measured RS and a CLI-RSRP leakage signal power or a CLI-RSSI is greater than or equal to an indicated SLR threshold associated with the RS.

In some implementations of the method and apparatuses described herein, the at least one processor is configured to transmit the PRACH preamble on the selected RO when a CLI-RSRP value or a CLI-RSSI value is smaller than or equal to a threshold value indicated by the RACH configuration message, an RA contention class is equal to an RA contention class indicated by the RACH configuration message, or an RA trigger event index is equal to or within trigger event indices indicated by the RACH configuration message.

In some implementations of the method and apparatuses described herein, the RACH configuration message indicates an index of valid ROs and a mapping of the valid ROs to synchronization signal blocks (SSBs) without consideration of any ROs deactivated for SBFD operations.

In some implementations of the method and apparatuses described herein, the UE receives the RACH configuration message from a network entity via system information block (SIB) signaling or dedicated signaling.

Some implementations of the method and apparatuses described herein may further include a processor for wireless communication, comprising at least one controller coupled with at least one memory and configured to cause the processor to receive a RACH configuration message for SBFD operations, and transmit a PRACH preamble on a selected RO, wherein the selected RO falls within an SBFD UL sub-band.

In some implementations of the method and apparatuses described herein, the at least one controller is further configured to cause the processor to receive a resource configuration message that indicates time symbols and frequency symbols used for the SBFD operations.

In some implementations of the method and apparatuses described herein, the RACH configuration message indicates at least one of an RSRP threshold associated with a an RS index set, a CLI threshold, an SLR threshold associated with a RS index set, a maximum PRACH uplink transmit power threshold associated with a RS index set, an RA contention class, an RA trigger event index, a deactivated ROs index, two preambleReceivedTargetPower values, and two uplink power ramping values.

In some implementations of the method and apparatuses described herein, the at least one controller is further configured to cause the processor to receive a CLI-RSRP or a CLI-RSSI measurement resource for measuring the CLI-RSRP or CLI-RSSI of a second UE.

In some implementations of the method and apparatuses described herein, the at least one controller is configured to transmit the PRACH preamble on the selected RO when a CLI-RSRP value or a CLI-RSSI value is smaller than or equal to a threshold value indicated by the RACH configuration message, an RA contention class is equal to an RA contention class indicated by the RACH configuration message, or an RA trigger event index is equal to or within trigger event indices indicated by the RACH configuration message.

In some implementations of the method and apparatuses described herein, the processor receives the RACH configuration message from a network entity via SIB signaling or dedicated signaling.

Some implementations of the method and apparatuses described herein may further include a method performed by a UE, the method comprising receiving a RACH configuration message for SBFD operations and transmitting a PRACH preamble on a selected RO, wherein the selected RO falls within an SBFD uplink (UL) sub-band.

In some implementations of the method and apparatuses described herein, the method further comprises receiving a resource configuration message that indicates time symbols and frequency symbols used for the SBFD operations.

In some implementations of the method and apparatuses described herein, the RACH configuration message indicates at least one of an RSRP threshold associated with an RS index set, a CLI threshold, an SLR threshold associated with an RS index set, a maximum PRACH uplink transmit power threshold associated with an RS index set, an RA contention class, an RA trigger event index, a deactivated ROs index, two preambleReceivedTargetPower values, and two uplink power ramping values.

Some implementations of the method and apparatuses described herein may further include network entity for wireless communication, comprising at least one memory, and at least one processor coupled with the at least one memory and configured to cause the network entity to determine a RACH configuration message associated with a UE, and transmit, to the UE, the RACH configuration message associated with identifying valid ROs for SBFD operations.

In some implementations of the method and apparatuses described herein, the at least one processor is configured to cause the network entity to transmit the RACH configuration message to the UE via SIB signaling or dedicated signaling.

In some implementations of the method and apparatuses described herein, the at least one processor is further configured to cause the network entity to deactivate one or more ROs, wherein the RACH configuration message identifies the deactivated one or more ROs.

In some implementations of the method and apparatuses described herein, the RACH configuration message indicates at least one of an RSPP threshold associated with an RS index set, a CLI threshold, an SLR threshold associated with an RS index set, a maximum PRACH uplink transmit power threshold associated with an RS index set, an RA contention class, an RA trigger event index, a deactivated ROs index, two preambleReceivedTargetPower values, and two uplink power ramping values.

### BRIEF DESCRIPTION OF THE DRAWINGS

FIG. 1 illustrates an example of a wireless communications system in accordance with aspects of the present disclosure.

FIG. 2 illustrates an example block diagram that depicts a wireless cell in accordance with aspects of the present disclosure.

FIG. 3 illustrates an example diagram that depicts a comparison of TDD and SBFD in accordance with aspects of the present disclosure.

FIG. 4 illustrates an example diagram that depicts CLI and SI during SBFD operations in accordance with aspects of the present disclosure.

FIG. 5 illustrates an example diagram that depicts valid RACH occasions within time slots in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In some wireless communication systems, user communication devices, such as UEs perform random access procedures when establishing (or re-establishing) connections with the network. The wireless communications systems may utilize SBFD operations for RACH procedures, such as by enabling the RACH procedures to occur during SBFD symbols.

However, while the use of SBFD symbols may reduce latency and/or increase cell coverage for RACH procedures, the network may experience an increase in CLI, such as inter-cell CLI, due to the unexpected and random behavior of PRACH preamble transmissions (performed during RACH procedures). Further, RACH occasions configured on SBFD symbols may exhibit self-interference (SI) and/or experience inter-cell CLI, which can cause the signal quality of received PRACH preambles during SBFD symbols to be weaker than the signal quality of received PRACH preambles on uplink only symbols (e.g., symbols without SBFD sub-bands).

Accordingly, a wireless communications system may implement certain conditions when allowing or facilitating PRACH preamble transmissions during SBFD symbols, in order to balance the drawbacks associated with the use of the SBFD symbols and the beneficial uses (e.g., reducing RA latency versus an increased inter-UE CLI).

The wireless communication system may implement limitations on which SBFD symbols and/or when certain SBFD slots/symbols may be associated with PRACH preamble transmissions (e.g., which RO of an SBFD slot/symbol). For example, the wireless communications system may allow UEs with a high RSRP to transmit PRACH preambles on an RO of a SBFD slot/symbol, because the UEs with the high RSRP often have high success probabilities for RACH procedures and utilize low uplink transmit power when transmitting PRACH preambles.

As another example, the wireless communications system may allow certain or specific RA contention classes and/or RA trigger events to utilize RO within SBFD slots/symbols (e.g., high priority RA trigger events). Further, the wireless communications systems may limit a total number of valid ROs in SBFD symbols for PRACH preamble transmissions, which can reduce or mitigate any inter-UE CLI by controlling the number of time-frequency resources available for the valid ROs (e.g., where a valid RO is an RO within an SBFD sub-band available for PRACH preamble transmissions).

Also, the wireless communications system may allow UEs with weak anticipated or predicted CLI to utilize SBFD slots/symbols, in order to avoid any potential strong CLI to occur during PRACH preamble transmissions. Thus, a wireless communications system may utilize various techniques when enabling the use of SBFD resources (e.g., slots or symbols) for RACH procedures, in order to balance the advantages of using the SBFD resources (e.g., low latency) with potential issues (e.g., increased CLI), among other benefits.

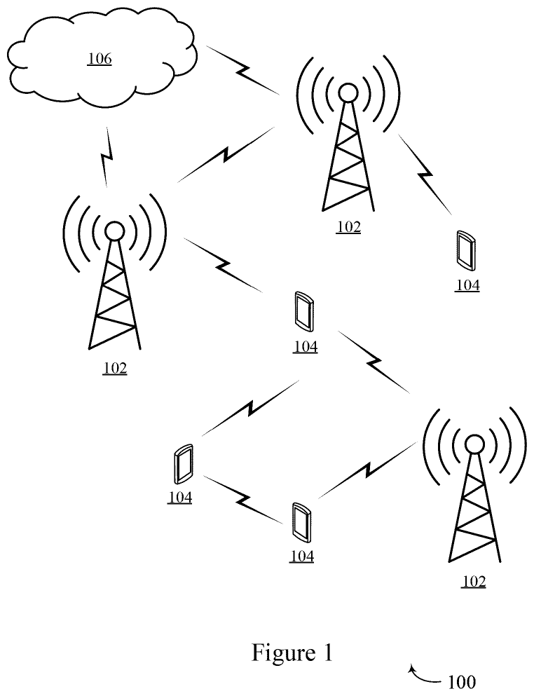

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

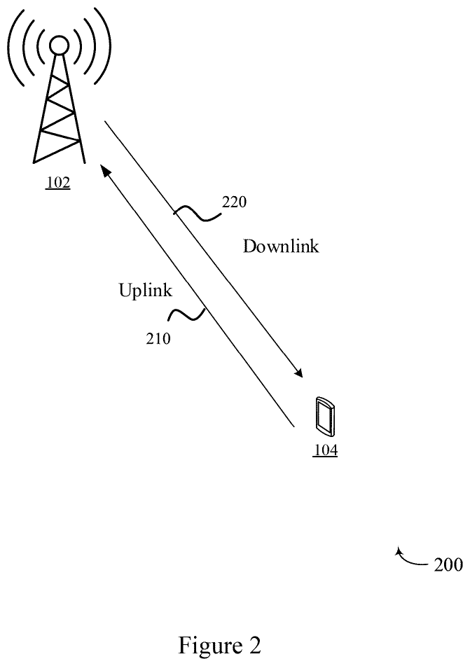

FIG. 2 illustrates an example block diagram that depicts a wireless cell 200 in accordance with aspects of the present disclosure. The wireless cell includes the UE 104 connected to the NE 102, such as a base station or gNB. As described herein, the NE 102 may be a RAN node operating via 4G, 5G, or 6G standard, and may be implemented as a TRP, a customer premises equipment (CPE), an integrated access/backhaul (IAB) node, a relay, and so on. Generally, the UE 104 transmits to the NE 102 over an uplink channel 210, and the NE 102 transmits to the UE over a downlink channel 220.

As described herein, the UE 104 may be configured with an SBFD resource configuration. Via SBFD, a sub-band in a bandwidth of the wireless link or channel (e.g., uplink channel 210 and/or downlink channel 220) is configured to perform communication in a direction that is different from the direction of communication in the rest of the bandwidth. For example, a UL sub-band on a DL symbol refers to a sub-band within the DL bandwidth that may be used for UL communications.

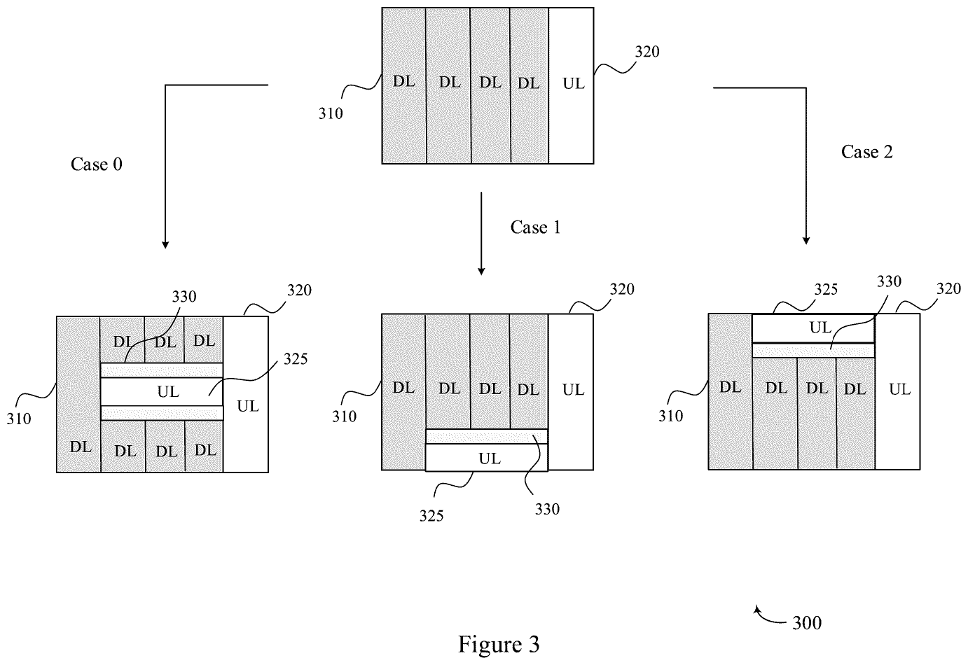

FIG. 3 illustrates an example diagram that depicts a comparison 300 of TDD and SBFD in accordance with aspects of the present disclosure. For example, a legacy DDDDU slot configuration (which includes four DL slots 310 and one UL slot 320) is reconfigured into three different (e.g., Cases 0, 1, 2) DXXXU slot configurations (e.g., one DL slot 310, three SBFD slots, and one UL slot 320).

The SBFD-based configurations generally allocate more UL resources to UL communications as compared to legacy TDD, which can increase the UL communications capacity and coverage. For example, the DL slots 310 include UL sub-bands 330, along with guard bands 330 located between adjacent sub-bands, such as between a DL sub-band and a UL sub-band. The guard bands 330 may be configured as a number of physical resource blocks (PRBs) on which the UE 104 does not receive or transmit signals.

In some cases, the UL frequency resources with SBFD-based configuration are available starting from slot #1 (e.g., via the UL sub-band 325), as opposed to legacy TDD-based configurations, where the UL frequency resources are only available at slot #4. This availability helps improve/reduce any UL communications latency as compared to legacy TDD-based configurations. A scheduling entity (e.g., the NE 102, such as a gNB) may utilize any of the cases 0, 1, or 2, depending on deployment scenarios, UE traffic needs, and so on.

Typically, wireless communications systems perform half-duplex operations, such as by employing transceivers that perform either Tx or RX using one antenna. However, when operating SBFD (or other advanced duplexing), the UE 104 or the NE 102 may communicate in DL and UL simultaneously. For example, dynamic/flexible TDD (d/f-TDD) and sub-band full-duplex (SBFD) allow cells in a vicinity to use the same resources in time and/or frequency domains for both DL and UL transmissions. However, this simultaneous operation may lead to CLI between base stations and/or between UEs.

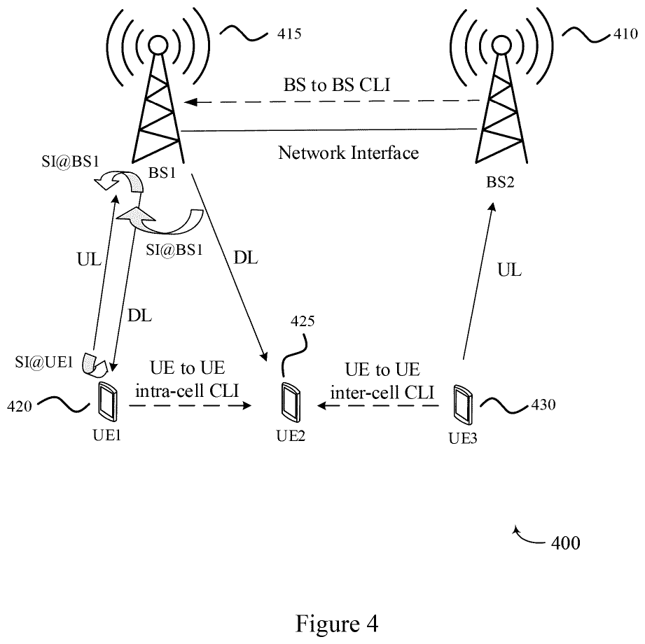

For example, in wireless communications systems that employ SBFD operations (e.g., SBFD-based systems), where the UL and DL communications occur at the same time but on different frequency resources, SI and CLI issues can arise. FIG. 4 illustrates an example diagram 400 that depicts CLI and SI during SBFD operations in accordance with aspects of the present disclosure.

As shown BS-to-CBS CLI occurs between base stations 410 and 415 (e.g., BS2 and BS1) and UE-to-UE CLI occurs between the different UEs 420, 425, and 430 (e.g., UE1, UE2, UE3).

In some cases, SI can occur, where a transmitted DL/UL signal by a network node (e.g., a BS or UE) leaks energy onto its received UL/DL signal. For example, SI at the BS1 occurs when a transmitted DL signal/channel by the BS1 leaks energy onto its received UL signal/channel, while SI at the UE1 occurs when a transmitted UL signal/channel by the UE1 leaks energy onto its received DL signal/channel.

In other cases, CLI can occur, where a transmitted DL/UL signal by a network node (e.g., a BS or UE) leaks energy onto a received UL/DL signal of a nearby node. For example, for BS-to-BS CLI, CLI at a “victim” BS (e.g., BS2) occurs when a transmitted DL signal/channel by an “aggressor” BS (e.g., BS1) leaks energy onto the received UL signal/channel by the victim BS.

As another example, for UE-to-UE CLI, CLI at a “victim” UE (e.g., UE2) occurs when transmitted UL signals/channels by “aggressor” UEs (e.g., UE1 and UE3) leak energy onto a received DL signal/channel at the victim UE. The UE-to-UE CLI can include intra-cell CLI (e.g., between the UE1 and the UE2) and/or inter-cell CLI (e.g., between the UE1 and the UE2).

As described herein, the wireless communications system 100 may implement certain conditions when allowing or facilitating PRACH preamble transmissions during SBFD symbols, in order to reduce or mitigate the occurrence of CLI.

In some embodiments, the UE 104 may receive an SBFD time-frequency resource configuration message, where the configuration message indicates time symbols and/or frequency resource blocks (RBs) used for SBFD operations. The UE 104 may receive the resource configuration message from a network node (e.g., a gNB) via SIB1 signaling and/or via dedicated signaling.

The network node (e.g., the gNB) may determine the RACH configuration for a SBFD-capable UE using various options. For example, if many SBFD-capable UEs are already scheduled, the network node may expect a large CLI between UEs. The network node, in this case, may select a RACH configuration that limits the CLI between the UEs (e.g., by increasing the indicated thresholds or allowing a specific RA contention class or trigger event).

As another example, the network node may determine the RACH configuration based on CSI information, scheduled traffic and/or associated priority for the scheduled traffic. When the majority of scheduled UEs have weak CSIs and/or have high traffic priority, the network node may determine the UEs cannot or may not handle an increase in CLI and select a RACH configuration that limits the CLI between the UEs.

Further, the network node may determine the RACH configuration based on the location of the UEs. For example, when a large number of the scheduled UEs are located in a certain location (e.g., at a hotspot), the network node may increase the indicated RSRP or SLR threshold and/or decrease the indicated maximum uplink transmit power threshold associated with an SSB covering the hotspot to limit the CLI between the UEs, as described herein.

Also, the network node may determine the RACH configuration based on a predicted or expected traffic demand in a certain area/location and/or at a certain time. For example, the network node may increase the indicated RSRP or SLR threshold and/or decrease the indicated maximum uplink transmit power threshold associated with an SSB covering a certain hotspot at a time known for heavy data traffic to limit the CLI between the UEs.

In some cases, the UE 104 may receive a RACH configuration message via the SIBI signaling and/or the dedicated signaling. The RACH configuration message may include one or all of the following indications or information: an RSRP threshold associated with a reference signal (RS) index set, a CLI (e.g., RSRP/RSSI) threshold, a signal-to-leakage ratio (SLR) threshold associated with an RS index set, a maximum PRACH uplink transmit power threshold associated with an RS index set, an RA contention class (e.g., contention-based, contention-free), an RA trigger event index (see Table 1, herein), a valid/invalid ROs category class/indexes (e.g., UL-only based ROs, SBFD based ROs), where some valid ROs within a UL sub-band are deactivated, two preambleReceivedTargetPower values (e.g., one to be used during the UL-only slots and another to be used during the SBFD slots), and/or two uplink power ramping values (e.g., one to be used during the UL-only slots and another to be used during the SBFD slots).

In some cases, the network node may associate one RSRP threshold with one or more RSs (e.g., SSBs or CSI-RSs). Because a SSB is generally configured to provide coverage for a certain area, the network node may provide or implement a different RSRP threshold for different SSB indices. For example, the SSB covering a hotspot area may be associated with an RSRP that is larger than that for an SSB covering a non-hotspot area.

In some cases, the network node may obtain knowledge about hotspot areas either via historical measurements, scheduling, and/or during network installation (for example, when the hotspot area is at a fixed and known location, such as a shopping mall). Thus, an RSRP maybe associated with one or more SSBs as indicated by an index set (e.g., which can include a one-to-one mapping and/or one-to-many mapping of SSBs to the RSRP).

Further, in some cases, the signal-to-leakage ratio (SLR) value may be calculated when a reference signal received power (RSRP) of a measured reference signal (RS) and a cross-link interference (CLI) RSRP (CLI-RSRP) leakage signal power or a CLI reference signal strength indicator (RSSI) (CLI-RSSI) is greater than or equal to an indicated SLR threshold associated with the RS.

Table 1 presents RA trigger events and their association to contention-based random access (CBRA) and contention-free random access (CFRA) classes:

TABLE 1

| | | RA Contention | |
|---|---|---|---|
| RA | | Class | |
| Index | RA Trigger Event | CBRA | CFRA |
| 1 | Initial access from RRC_IDLE | Yes | — |
| 2 | RRC Connection Re-establishment procedure | Yes | — |
| 3 | Mobility / Handover (HO) | Yes | Yes |
| 4 | Beam Failure Recovery (BFR) | Yes | Yes |
| 5 | Resume RRC Connection from | Yes | — |
| | RRC_INACTIVE | | |
| 6 | DL Out-of-Sync | Yes | Yes |
| 7 | UL Out-of-Sync | Yes | — |
| 8 | Request by RRC upon synchronous | Yes | Yes |
| | reconfiguration | | |
| 9 | To establish time alignment for a secondary | Yes | Yes |
| | TAG | | |
| 10 | Scheduling Request (SR) failure | Yes | — |
| 11 | Request for On-demand System Information | Yes | Yes |
| | (SI) | | |

In some cases, such as when one or more of the valid ROs fall within the SBFD UL sub-band and the remaining valid ROs fall within the UL-only symbols, the UE 104 transmits a PRACH preamble on a valid RO falling within the SBFD UL sub-band based on one or more conditions being met or satisfied.

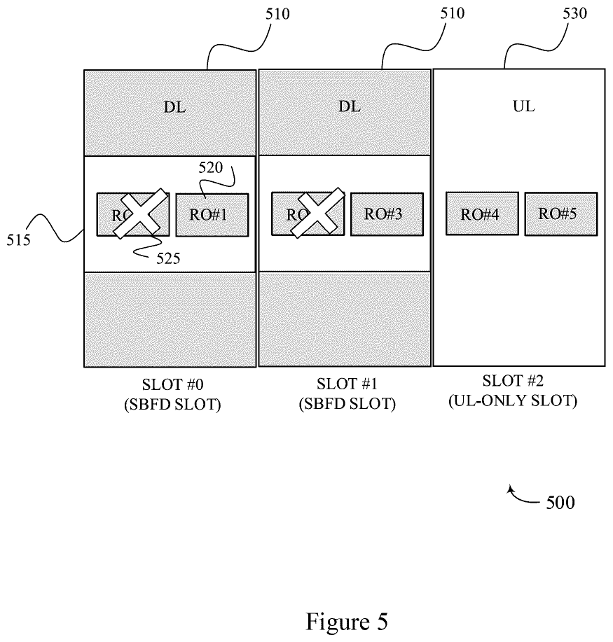

FIG. 5 illustrates an example diagram 500 that depicts valid RACH occasions within time slots in accordance with aspects of the present disclosure. The diagram 500 depicts a configuration of one or more SBFD slots 510 (e.g., slot #0 and slot #1), which include UL sub-bands 515, and a UL-only slot 530 (e.g., Slot #2). Each of the slots includes ROs, such as valid ROs 520, where some of the ROs are deactivated ROs 525, as described herein.

The one or more conditions may include:

An RSRP value of a measured reference signal (RS) (e.g., an SSB, a CSI-RS, or so on) is greater than or equal to an indicated RSRP threshold associated with the RS;

An anticipated CLI-RSRP/CLI-RSSI value is smaller than or equal to an indicated CLI-RSRP/CLI/RSSI threshold. For example, the UE 104 (e.g., in connected-mode) is provided with CLI-RSRP/CLI-RSSI measurement resources (e.g., via the RACH configuration message or via a separate CLI configuration message), which are used to measure the CLI-RSRP/CLI-RSSI from nearby UEs. The UE 104 acts as victim UE “victim” UE. In some cases, the received CLI (e.g., RSRP/RSSI) may be used to predict/anticipate the CLI the UE 104 may cause to its nearby UEs when it transmits a PRACH preamble (e.g., when it becomes an “aggressor” UE to its nearby UEs). For example, the UE 104 compares L1/L2 CLI-RSRP/L1/L2 CLI-RSSI measurements with an indicated threshold. As another example, the UE 104 compares filtered L3 CLI-RSRP/L3 CLI-RSSI measurements with the indicated threshold;

An intended RA contention class is equal to an indicated RA contention class;

An intended RA trigger event index is equal to or within indicated RA trigger event indexes; and so on.

When one or more of the above conditions are met, the UE 104 determines the transmit power of the PRACH preamble based on a provided preambleReceivedTargetPower of SBFD slots and a provided maximum PRACH uplink transmit power threshold associated with the RS of the PRACH preamble index. In some cases, the preambleReceivedTargetPower of SBFD slots is indicated explicitly to the UE 104. In other cases, the preambleReceivedTargetPower of SBFD slots is indicated with respect to the preambleReceivedTargetPower of the UL-only slots (e.g., by indicating an offset value).

In response, the UE 104 may wait for a network response (e.g., via Msg2 or MsgB of a RACH procedure). If no response is received, the UE 104 performs a second transmission attempt of a PRACH preamble after applying a power ramping using the uplink power ramping of the SBFD slots. In some cases, the power ramping of SBFD slots is indicated explicitly to the UE 104. In other cases, the power ramping of SBFD slots is indicated with respect to the power ramping of the UL-only slots (e.g., by indicating an offset value).

In some cases, case such as when the UE 104 receives an indication of the deactivated ROs 525, the indexing of ROs and/or the mapping of SSBs to ROs is performed without considering the deactivated ROs.

Of course, the systems and methods described herein may be applicable in all FD directions, such as UL sub-bands on DL symbols/slots and/or DL sub-bands on UL symbols/slots.

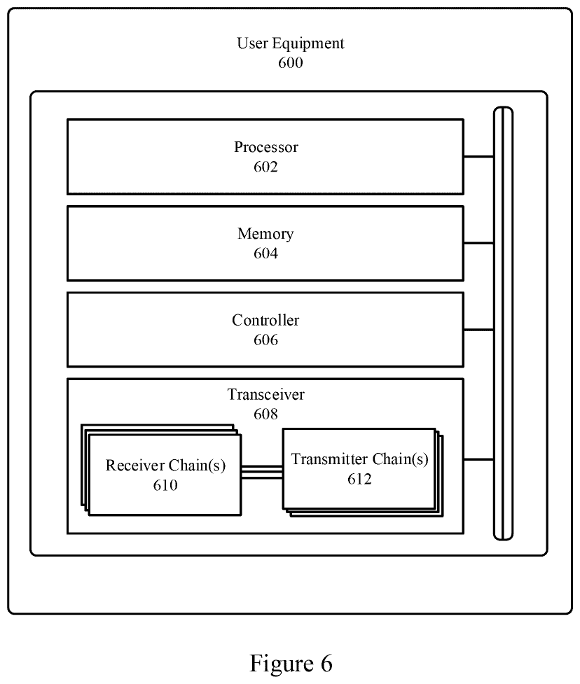

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604).

For example, the processor 602 may support wireless communication at the UE 600 in accordance with examples as disclosed herein. The UE 600 may be configured to support a means for receiving a RACH configuration message for SBFD operations and transmitting a PRACH preamble on a selected RO, wherein the selected RO falls within an SBFD uplink UL sub-band.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

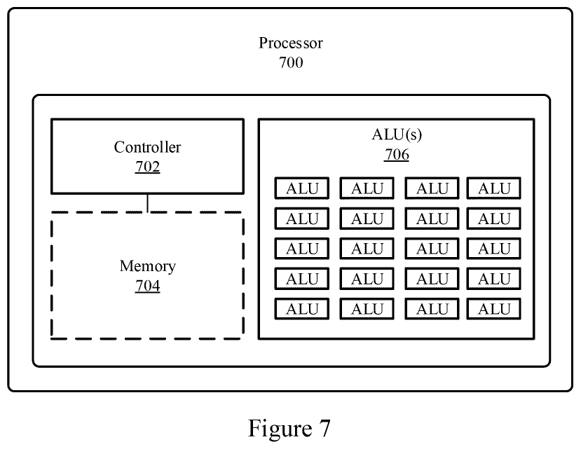

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. For example, the controller 702 may support wireless communication at the processor 700 in accordance with examples as disclosed herein. The processor 700 may be configured to support a means for receiving a RACH configuration message for SBFD operations and transmitting a PRACH preamble on a selected RO, wherein the selected RO falls within an SBFD uplink UL sub-band.

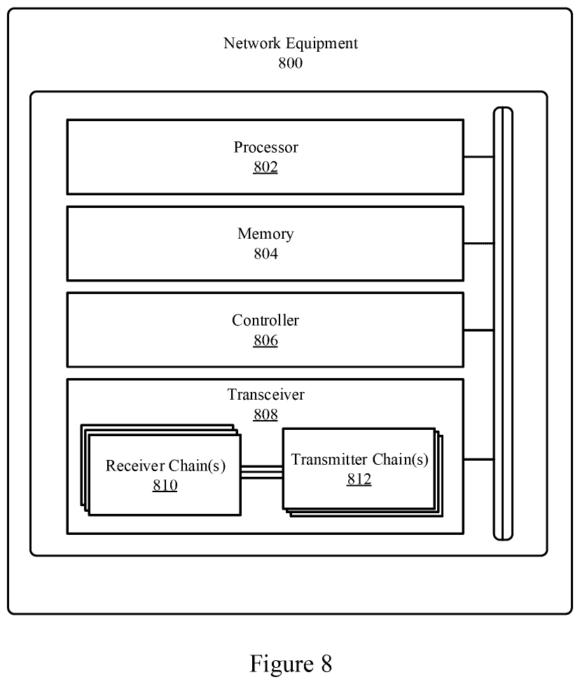

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804).

For example, the processor 802 may support wireless communication at the NE 800 in accordance with examples as disclosed herein. The NE 800 may be configured to support a means for determining a RACH configuration message associated with a UE, and transmitting, to the UE, the RACH configuration message associated with identifying valid ROs for SBFD operations.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

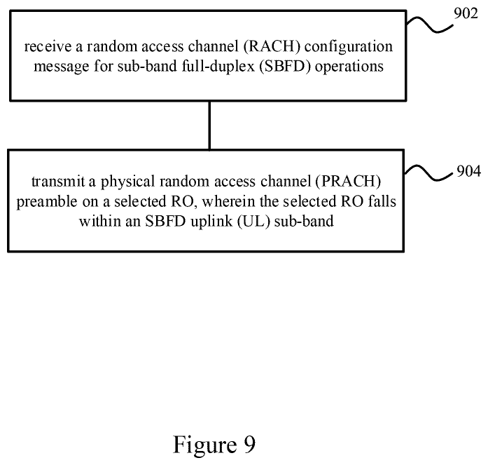

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving a RACH configuration message for SBFD operations. The operations of 902 may be performed in accordance with examples as described herein. In some implementations, aspects of the operations of 902 may be performed by a UE as described with reference to FIG. 6.

At 904, the method may include transmitting a PRACH preamble on a selected RO, wherein the selected RO falls within an SBFD uplink UL sub-band. The operations of 904 may be performed in accordance with examples as described herein. In some implementations, aspects of the operations of 904 may be performed by a UE as described with reference to FIG. 6.

It should be noted that the method described herein describes a possible implementation, and that the operations and the steps may be rearranged or otherwise modified and that other implementations are possible.

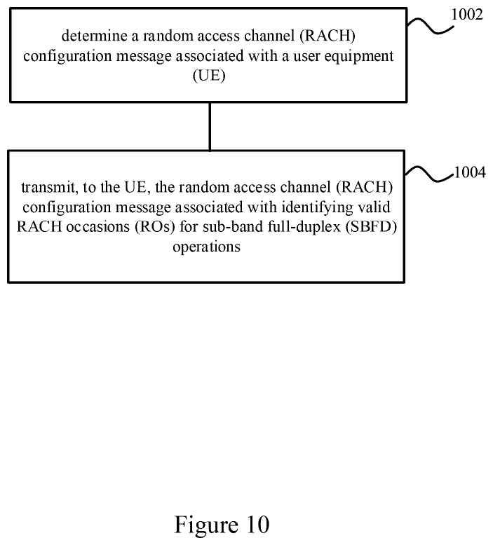

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include determining a RACH configuration message associated with a UE. The operations of 1002 may be performed in accordance with examples as described herein. In some implementations, aspects of the operations of 1002 may be performed by an NE as described with reference to FIG. 8.

At 1004, the method may include transmitting, to the UE, the RACH configuration message associated with identifying valid ROs for SBFD operations. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a random access channel (RACH) configuration message for sub-band full-duplex (SBFD) operations; and
transmit a physical random access channel (PRACH) preamble on a selected RACH occasion (RO),
wherein the selected RO falls within an SBFD uplink (UL) sub-band.

2. The UE of claim 1, wherein the at least one processor is further configured to cause the UE to:
receive a resource configuration message that indicates time symbols and frequency symbols used for the SBFD operations.

3. The UE of claim 1, wherein the RACH configuration message indicates at least one of:
a reference signal received power (RSRP) threshold associated with a reference signal (RS) index set;
a cross-link interference (CLI) threshold;
a signal-to-leakage ratio (SLR) threshold associated with an RS index set;
a maximum PRACH uplink transmit power threshold associated with an RS index set;
a random access (RA) contention class;
an RA trigger event index;
a deactivated ROs index;
two preambleReceivedTargetPower values; and
two uplink power ramping values.

4. The UE of claim 3, wherein a first preambleReceivedTargetPower value of the two preambleReceivedTargetPower values is used to determine a PRACH transmit power during SBFD slots and a second preambleReceivedTargetPower value of the two preambleReceivedTargetPower values is used to determine the PRACH transmit power during UL-only slots.

5. The UE of claim 4, wherein the determined PRACH transmit power does not exceed the maximum PRACH uplink transmit power threshold associated with the RS index set.

6. The UE of claim 4, wherein the preambleReceivedTargetPower value of SBFD slots is explicitly indicated to the UE.

7. The UE of claim 4, wherein the preambleReceivedTargetPower value of SBFD slots is indicated relative to the preambleReceivedTargetPower value of the UL-only slots.

8. The UE of claim 3, wherein a first uplink power ramping value of the two uplink power ramping values is used to increase a PRACH transmit power during the SBFD slots, and a second uplink power ramping value of the two uplink power ramping values is used to increase the PRACH transmit power during UL-only slots.

9. The UE of claim 8, wherein the uplink power ramping value of SBFD slots is explicitly indicated to the UE.

10. The UE of claim 8, wherein the uplink power ramping value of SBFD slots is indicated relative to the uplink power ramping value of the UL-only slots.

11. The UE of claim 1, wherein the at least one processor is further configured to cause the UE to:
receive a cross-link interference reference signal received power (CLI-RSRP) or a CLI-reference signal strength indicator (RSSI) measurement resource for measuring the CLI-RSRP or CLI-RSSI of a second UE.

12. The UE of claim 1, wherein the at least one processor is configured to transmit the PRACH preamble on the selected RO when a reference signal received power (RSRP) value of a measured reference signal (RS) is greater than or equal to an indicated RSRP threshold associated with the RS.

13. The UE of claim 1, wherein the at least one processor is configured to transmit the PRACH preamble on the selected RO when:
a signal-to-leakage ratio (SLR) value determined using a reference signal received power (RSRP) of a measured reference signal (RS) and a cross-link interference (CLI) RSRP (CLI-RSRP) leakage signal power or a CLI reference signal strength indicator (RSSI) (CLI-RSSI) is greater than or equal to an indicated SLR threshold associated with the RS.

14. The UE of claim 1, wherein the at least one processor is configured to transmit the PRACH preamble on the selected RO when:
a cross-link interference reference signal received power (CLI-RSRP) value or a CLI-reference signal strength indicator (RSSI) value is smaller than or equal to a threshold value indicated by the RACH configuration message;
a random access (RA) contention class is equal to an RA contention class indicated by the RACH configuration message; or
an RA trigger event index is equal to or within trigger event indices indicated by the RACH configuration message.

15. The UE of claim 1, wherein the RACH configuration message indicates an index of valid ROs and a mapping of valid ROs to synchronization signal blocks (SSBs) without consideration of any ROs deactivated for SBFD operations.

16. The UE of claim 1, wherein the UE receives the RACH configuration message from a network entity via system information block (SIB) signaling or dedicated signaling.

17. A processor for wireless communication, comprising:
at least one controller coupled with at least one memory and configured to cause the processor to:
receive a random access channel (RACH) configuration message for sub-band full-duplex (SBFD) operations; and
transmit a physical random access channel (PRACH) preamble on a selected RACH occasion (RO),
wherein the selected RO falls within an SBFD uplink (UL) sub-band.

18. A method performed by a user equipment (UE), the method comprising:
receiving a random access channel (RACH) configuration message for sub-band full-duplex (SBFD) operations; and
transmitting a physical random access channel (PRACH) preamble on a selected RACH occasion (RO),
wherein the selected RO falls within an SBFD uplink (UL) sub-band.

19. A network entity for wireless communication, comprising:
at least one memory; and
at least one processor coupled with the at least one memory and configured to cause the network entity to:
determine a random access channel (RACH) configuration message associated with a user equipment (UE); and
transmit, to the UE, the RACH configuration message associated with identifying valid RACH occasions (ROs) for sub-band full-duplex (SBFD) operations.

20. The network entity of claim 19, wherein the at least one processor is configured to cause the network entity to transmit the RACH configuration message to the UE via system information block (SIB) signaling or dedicated signaling.
